(19) United States
(12) Patent Application Publication
(10) Pub. No.: US 2009/0192789 A1
(43) Pub. Date: Jul. 30, 2009

(54) METHOD AND APPARATUS FOR ENCODING/DECODING AUDIO SIGNALS

(75) Inventors: Geon-hyoung LEE, Hwanseong-si (KR); Chul-woo Lee, Suwon-si (KR); Jong-hoon Jeong, Suwon-si (KR); Nam-suk Lee, Suwon-si (KR); Han-gil Moon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/362,060

(22) Filed: Jan. 29, 2009

(30) Foreign Application Priority Data
Jan. 29, 2008 (KR) 10-2008-0009007

(51) Int. Cl. G10L 11/04; G10L 19/04

(52) U.S. Cl. 704/206; 704/219; 704/E11.006; 704/E19.023

(57) ABSTRACT

Provided are a method and apparatus for effectively encoding/decoding remaining difference signals excluding sinusoidal components, from input audio signals. In the method and apparatus for encoding audio signals, sinusoidal analysis is performed on low frequency signals of less than a predetermined critical frequency in order to extract sinusoidal signals and then, an encoding operation is performed on the remaining difference signals excluding the sinusoidal signals, from input audio signals, by using linear prediction coding (LPC) analysis.

### CROSS-REFERENCE TO RELATED PATENT APPLICATIONS

This application claims priority from Korean Patent Application No. 10-2008-0009007, filed on Jan. 29, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to encoding/decoding audio signals, and more particularly, to encoding/decoding remaining difference signals excluding sinusoidal components, from input audio signals by performing linear prediction coding (LPC) analysis.

2. Description of the Related Art

Related art audio encoding apparatuses having high sound quality mainly employ a time-frequency transform encoding method. In the time-frequency transform encoding method, input audio signals are encoded using coefficients obtained by transforming the audio signals by performing a frequency space transformation such as modified discrete cosine transformation. However, in the encoding method, as a target bit rate is decreased, the quality of sound expressed is lowered. Thus, it is difficult to encode audio signals at a low bit rate.

A parametric encoding method is a method of encoding audio signals at a low bit rate. Examples of parametric encoding methods include harmonic and individual lines plus noise (HINL), sinusoidal coding (SSC) etc. In the parametric encoding method, original audio signals are modeled to be comprised of component signals having a predetermined characteristic, and the component signals are detected from the audio signals and then parameters indicating the characteristic of the detected component signals are encoded. For example, when audio signals are comprised of a plurality of sinusoidal waves, the sinusoidal waves are detected from the audio signals, and only frequencies, phases, and amplitudes of the detected sinusoidal waves are encoded so that the audio signal can be encoded at a low bit rate.

FIG. 1 is a schematic block diagram of a related art apparatus for encoding parametric audio signals. The apparatus 100 for encoding parametric audio signals, illustrated in FIG. 1, assumes that audio signals comprise transient signals, sinusoidal waves, and noise. A transient encoding unit 110 extracts parameters based on transient components included in input audio signals so as to encode the audio signals. A sinusoidal encoding unit 120 extracts parameters based on sinusoidal signals included in input audio signals so as to encode the audio signals. A noise encoding unit 130 extracts parameters based on noise components included in input audio signals so as to encode the audio signals. The extracted parameters are formatted as bit streams using a bit stream formatting unit 140.

In this way, the related art apparatus for encoding parametric audio signals encode input audio signals as sinusoidal waves and noise components and additionally encodes transient components to improve sound quality. However, in the prior art, when an available bit rate is limited, i.e., when audio signals are encoded at a low bit rate, the amount of bits allocated to sinusoidal signals in a high frequency band, which are relatively not as important in terms of human psychoacoustics, is reduced. In this case, only noise components or transient components are included in decoded high frequency signals so that a larger loss of sound quality, compared to original sound, occurs.

### SUMMARY OF THE INVENTION

Accordingly, it is an aspect of the present invention to provide a method and apparatus for effectively encoding/decoding signals having remaining components, where sinusoidal components are subtracted from audio signals at a low bit rate without a large loss of sound quality, in particular, high frequency component signals.

According to an exemplary embodiment of the present invention, there is provided a method of encoding audio signals, the method including: performing sinusoidal analysis on low frequency signals of less than a predetermined critical frequency included in the audio signals in order to extract sinusoidal signals; performing linear prediction coding (LPC) analysis on remaining difference signals excluding the sinusoidal signals extracted from the audio signals to generate LPC coefficients and residual signals of the difference signals; extracting gain information about the residual signals of the difference signals; and multiplexing the sinusoidal signals, the LPC coefficients of the difference signals, and the gain information about the residual signals of the difference signals.

According to another exemplary embodiment of the present invention, there is provided an apparatus for encoding audio signals, the apparatus including: a sinusoidal extracting unit performing sinusoidal analysis on low frequency signals of less than a predetermined critical frequency included in the audio signals in order to extract sinusoidal signals; a linear prediction coding (LPC) analyzing unit performing LPC analysis on remaining difference signals excluding the sinusoidal signals extracted from the audio signals to generate LPC coefficients and residual signals of the difference signals; an envelope coding unit extracting gain information about the residual signals of the difference signals; and a multiplexing unit multiplexing the sinusoidal signals, the LPC coefficients of the difference signals, and the gain information about the residual signals of the difference signals.

According to another exemplary embodiment of the present invention, there is provided a method of decoding audio signals, the method including: performing a decoding operation on sinusoidal signals which are extracted from low frequency signals less than a predetermined critical frequency signal included in bit streams and which are encoded; generating noise of the low frequency signals using a predetermined random signal generation function and combining the noise with the sinusoidal signals so as to decode the low frequency signals; generating residual signals of high frequency signals of the audio signals by using the decoded low frequency signals; performing linear prediction coding (LPC) synthesis using LPC coefficients of the high frequency signals included in the bit streams and residual signals of the high frequency signals so as to decode the high frequency signals; and combining the decoded low frequency signals with the high frequency signals so as to decode the audio signals.

According to another exemplary embodiment of the present invention, there is provided an apparatus for decoding audio signals, the apparatus including: a low frequency signal decoding unit performing a decoding operation on sinusoidal signals which are extracted from low frequency signals less than a predetermined critical frequency signal included in bit streams and which are encoded, and combining the noise of the low frequency signals generated using a predetermined random signal generation function with the sinusoidal signals in order to decode the low frequency signals; a high frequency sinusoidal signal generating unit generating residual signals of high frequency signals of the audio signals by using the decoded low frequency signals; a linear prediction coding (LPC) synthesizing unit performing LPC synthesis using LPC coefficients of the high frequency signals included in the bit streams and residual signals of the high frequency signals so as to decode the high frequency signals; and a combining unit combining the decoded low frequency signals with the high frequency signals to decode the audio signals.

### BRIEF DESCRIPTION OF THE DRAWINGS

The above and other aspects of the present invention will become more apparent by describing in detail exemplary embodiments thereof with reference to the attached drawings in which:

FIG. 1 is a schematic block diagram of a related art apparatus for encoding parametric audio signals;

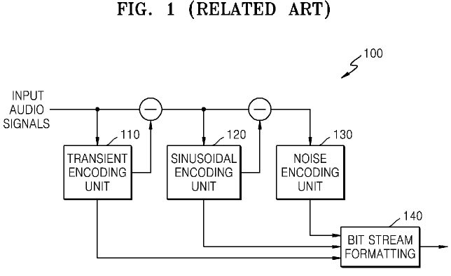

FIG. 2 is a block diagram of an apparatus for encoding audio signals according to an exemplary embodiment of the present invention;

FIG. 3 is a flowchart illustrating a method of encoding audio signals according to an exemplary embodiment of the present invention;

FIG. 4 is a block diagram of an apparatus for decoding audio signals according to an exemplary embodiment of the present invention;

FIG. 5 is a detailed block diagram illustrating a configuration of an exemplary embodiment of a low frequency signal decoding unit of FIG. 4;

FIG. 6 is a detailed block diagram illustrating a configuration of an exemplary embodiment of a high frequency residual signal generating unit of FIG. 4; and

FIG. 7 is a flowchart illustrating a method of decoding audio signals according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

In a method and apparatus for encoding audio signals according to exemplary embodiments of the present invention, sinusoidal signals are extracted from input audio signals and are encoded, and encoding and decoding of remaining difference signals, excluding the sinusoidal signals that are subtracted from the input audio signals, are performed using linear prediction coding (LPC).

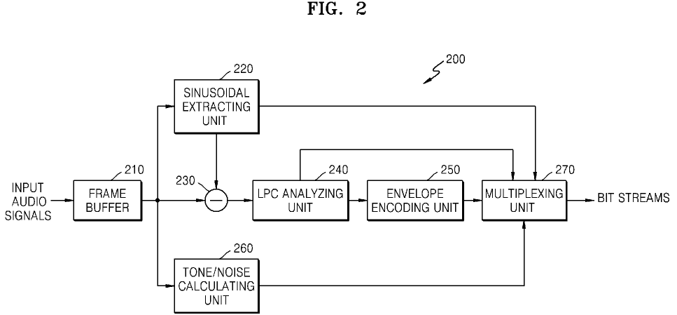

FIG. 2 is a block diagram of an apparatus for encoding audio signals according to an exemplary embodiment of the present invention. Referring to FIG. 2, the apparatus 200 for encoding audio signals according to an exemplary embodiment of the present invention comprises a frame buffer 210, a sinusoidal extracting unit 220, a subtracting unit 230, a linear prediction coding (LPC) analyzing unit 240, an envelope encoding unit 250, a tone/noise calculating unit 260, and a multiplexing unit 270.

The frame buffer 210 divides input audio signals into frames having a predetermined length which are processing units, and then stores and outputs the frames. The sinusoidal extracting unit 220 performs sinusoidal analysis on low frequency signals of less than a predetermined critical frequency included in the input audio signals in order to extract and encode the sinusoidal signals. In other words, the sinusoidal extracting unit 220 extracts and encodes the sinusoidal signals included in low frequency signals of less than the predetermined critical frequency. The sinusoidal signals may be detected using a matching pursuit (MP) algorithm or fast Fourier transformation (FFT).

When a sinusoidal detection method using FFT is employed, an FFT operation is performed on input low frequency signals and then the peak of each sinusoidal wave having a different frequency is sought so that the magnitude and phase of each sinusoidal wave are detected. When a sinusoidal detection method using MP is employed, a fundamental frequency is sought using a pitch period, and parameters of sinusoidal waves are retrieved using a predetermined sinusoidal dictionary. Here, magnitude and phase information are included in parameters of sinusoidal parameters. Sinusoidal signal components included in low frequency signals of less than a predetermined critical frequency may be extracted using various other known sinusoidal extracting algorithms apart from the above-described FFT and MP.

When the sinusoidal signals are extracted from the low frequency signals, the subtracting unit 230 subtracts the sinusoidal signals extracted from input audio signals to generate difference signals. Here, low frequency noise components, high frequency tone, and high frequency noise components are included in the difference signals. According to exemplary embodiments of the present invention, signals having remaining components subtracted from low frequency sinusoidal signals are modeled and encoded using LPC analysis so that previously unencoded components are encoded to improve sound quality.

To this end, the LPC analyzing unit 240 performs LPC analysis on the difference signals to output LPC coefficients of the difference signals and residual signals. LPC analysis is a method by which fundamental parameters of voice are extracted from the difference signals based on a linear model of voice generation. LPC analysis is a voice signal modeling method based on the assumption that current voice signal sample values are approximate to a linear combination of past M (where M is a positive integer) voice output sample values. The method and apparatus for encoding audio signals according to exemplary embodiments of the present invention apply such LPC analysis to the difference signals. The LPC analyzing unit 240 extracts LPC coefficients and residual signals from the difference signals by using a covariance method, an autocorrelation method, a lattice filter, a Levinson-Durbin algorithm etc. and outputs the LPC coefficients and the residual signals.

Specifically, it is assumed that the LPC analyzing unit 240 models current difference signal sample values using previous p (where p is a positive integer) difference signal samples s(n−1), s(n−2), through to s(n−p), as shown in equation 1.

$$s ( n ) = {\sum }_{i = 1}^{p} {a}_{i} s ( n - i ) + Gu ( n ) \qquad ( 1 )$$

u(n) represents a prediction error value when current difference signal sample values are predicted from previous p difference signal samples according to LPC analysis and is referred to as an excitation signal or a residual signal. Hereinafter, when describing the present invention, Gu(n) is defined as a residual signal of a difference signal. G represents a gain due to an energy of a residual signal. ai represents LPC coefficients, and p represents degrees of the LPC coefficients having values from 10 to 16.

Equation 1 may be transformed using z-transform, as shown in equation 2.

$$H ( z ) = \frac{s ( z )}{u ( z )} = \frac{G}{1 - {\sum }_{i = 1}^{p} {a}_{i} {z}^{- 1}} = \frac{G}{A ( z )} \qquad ( 2 )$$

In equation 2, a denominator of a transfer function H(z) is expressed as A(z).

Meanwhile, a residual signal Gu(n) (may also be indicated by e(n)) of equation 1 is expressed as shown in equation 3.

$$Gu ( n ) = e ( n ) = s ( n ) - {\sum }_{k = 1}^{p} {a}_{i} s ( n - k ) \qquad ( 3 )$$

A transfer function of a difference signal corresponding to a prediction error may be expressed as shown in equation 4.

$$A ( z ) = \frac{E ( z )}{S ( z )} = 1 - {\sum }_{k = 1}^{p} {a}_{k} {z}^{- k} \qquad ( 4 )$$

When considering equations 2 and 4, it can be understood that the transfer function of the residual signal corresponds to a denominator of the transfer function H(z). Thus, LPC coefficients ai are calculated using LPC analysis to determine A(z), and high frequency signals are input to A(z) and are filtered so that a residual signal Gu(n) can be extracted.

In this way, the LPC analyzing unit 240 performs LPC analysis on the difference signals so as to output LPC coefficients for generating prediction signals of the difference signals and residual signals corresponding to prediction errors.

The envelope encoding unit 250 extracts a gain value G from the residual signals and encodes the residual signals. Specifically, the envelope encoding unit 250 divides time envelopes of the residual signals by a predetermined time and generates parameters indicating a change in magnitudes of time envelopes of the residual signals using an energy of each divided section. As an example, the envelope encoding unit 250 calculates an averaged energy of each divided section of the residual signals and may use the calculated energy as a representative value indicating the magnitude of each divided section of the residual signals.

The tone/noise calculating unit 260 calculates the ratio of tone to noise components in all frequency bands of input audio signals and outputs the audio signals to the multiplexing unit 270 so as to improve additional sound quality.

The multiplexing unit 270 multiplexes encoded data of the sinusoidal signals in a low frequency band, LPC coefficients of the difference signals, and gain information and tone/noise ratio information etc. to generate and output bit streams.

In this way, in the method and apparatus for encoding audio signals according to exemplary embodiments of the present invention, the sinusoidal waves in a low frequency band are extracted from input audio signals and the audio signals are encoded. Then, the other difference signals included in the input audio signals are encoded using LPC analysis so that low frequency noise and high frequency tone and noise components, which have been considered simply as noise and encoded using only simple parameters in the prior art, can be effectively coded.

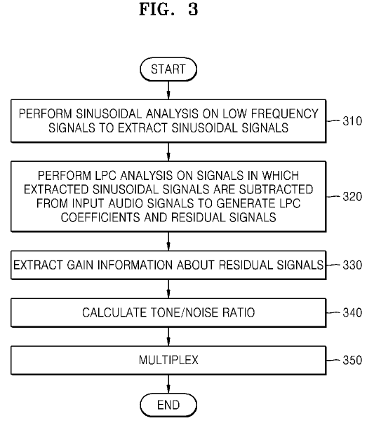

FIG. 3 is a flowchart illustrating a method of encoding audio signals according to an exemplary embodiment of the present invention.

Referring to FIG. 3, in operation 310, sinusoidal analysis is performed on low frequency signals of less than a predetermined critical frequency, which are included in audio signals, so that sinusoidal signals can be extracted and encoded.

In operation 320, LPC analysis is performed on remaining difference signals subtracted from the sinusoidal signals so that LPC coefficients of the difference signals and residual signals can be generated. Here, noise components of low frequency signals, tone components of high frequency signals, and noise components of high frequency signals are included in the difference signals.

In operation 330, gain information about the residual signals is extracted from the difference signals generated as a result of LPC analysis. Parameter information in which time envelopes of the residual signals are modeled may be used as gain information. In this case, the time envelopes of the residual signals may be divided into predetermined sections, and an average energy of each divided section may be calculated, and the calculated average energy may be used as parameters indicating a change in magnitudes of the time envelopes of the residual signals.

In operation 340, tone to noise ratio of the input audio signals are calculated. Specifically, the audio signals are transformed into the frequency domain, and the ratio of tone to noise components is calculated in a predetermined frequency band unit, and parameters indicating the ratio of tone to noise components may be set in each frequency band unit. The parameters about the tone to noise ratio are multiplexed to bit streams and are used as improvement layer information for improving sound quality.

In operation 350, the sinusoidal signals extracted from the low frequency signals, LPC coefficients of the difference signals, and gain information about the residual signals of the difference signals are multiplexed to generate bit streams.

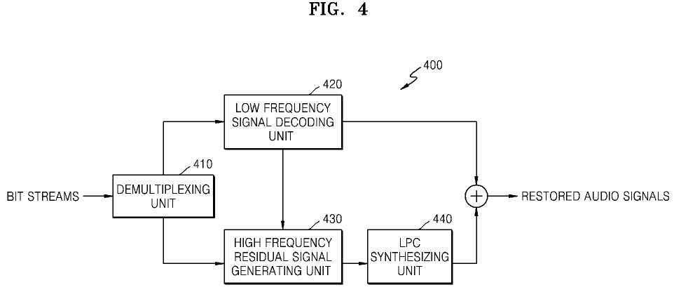

FIG. 4 is a block diagram of an apparatus for decoding audio signals according to an exemplary embodiment of the present invention.

Referring to FIG. 4, the apparatus 400 for decoding audio signals according to an exemplary embodiment of the present invention comprises a demultiplexing unit 410, a low frequency signal decoding unit 420, a high frequency residual signal generating unit 430, and an LPC synthesizing unit 440.

The demultiplexing unit 410 performs demultiplexing on bit streams in order to extract encoded sinusoidal signals in a low frequency band, LPC coefficients of difference signals, gain information, etc.

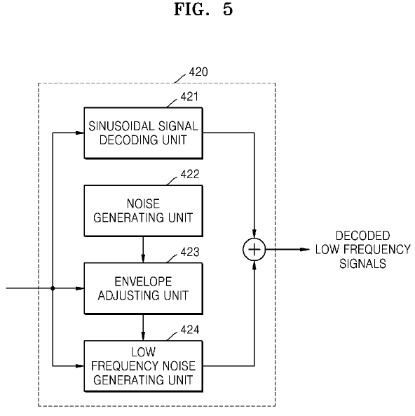

The low frequency signal decoding unit 420 decodes the sinusoidal signals, generates noise in a low frequency band using a predetermined random signal generation function, combines the decoded sinusoidal signals in the low frequency band with noise so as to decode signals in the low frequency band and outputs the signals. Specifically, referring to FIG. 5, which specifically illustrates a configuration of an exemplary embodiment of the low frequency signal decoding unit 420 of FIG. 4, the low frequency signal decoding unit 420 comprises a sinusoidal signal decoding unit 421, a noise generating unit 422, an envelope adjusting unit 423, and a low frequency noise generating unit 424. The sinusoidal signal decoding unit 421 extracts frequency information, amplitudes, and phase information about the sinusoidal signals in the low frequency band included in bit streams so as to generate and output low frequency sinusoidal signals. The noise generating unit 422 generates random signals using the random signal generation function, and the envelope adjusting unit 423 extracts gain information about the residual signals of the difference signals from the bit streams and adjusts envelopes of the random signals by using the extracted gain information to generate prediction noise signals of the low frequency signals. The low frequency noise generating unit 424 performs LPC synthesis using the LPC coefficients and the prediction noise signals extracted from the bit streams so as to generate noise in the low frequency band. The noise in the low frequency band generated in this way and the sinusoidal signals in the low frequency band are combined with one another so that the low frequency signals are decoded.

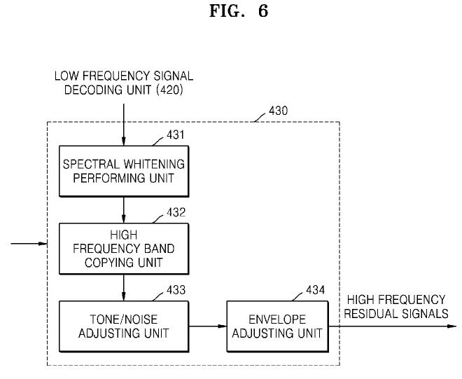

Referring back to FIG. 4, the high frequency residual signal generating unit 430 generates the residual signals in the high frequency band using the decoded low frequency signals. Specifically, referring to FIG. 6 which is a block diagram specifically illustrating a configuration of an exemplary embodiment of the high frequency residual signal generating unit 430, the high frequency residual signal generating unit 430 comprises a spectral whitening performing unit 431, a high frequency band copying unit 432, a tone/noise adjusting unit 433, and an envelope adjusting unit 434.

The spectral whitening performing unit 431 extracts residual signals from which envelopes are removed, from decoded low frequency signals. As an example, the spectral whitening performing unit 431 may perform LPC analysis in order to generate residual signals of the decoded low frequency signals. In this case, the spectral whitening performing unit 431 may performing LPC analysis by using LPC coefficient degrees which are the same as encoded difference signals, by using degree information about the LPC coefficients output from bit streams.

The high frequency band copying unit 432 copies the residual signals of the low frequency signals output by the spectral whitening performing unit 431 in a predetermined high frequency band. The high frequency signals copied from the low frequency residual signals by the high frequency band copying unit 432 correspond to prediction signals for predicting the residual signals of the difference signals positioned in the high frequency band.

The tone/noise adjusting unit 433 adds tone and noise to the signals copied in the high frequency band using information about the ratio of tone to noise included in the bit streams.

The envelope adjusting unit 434 divides the copied signals output from the tone/noise adjusting unit 433 into predetermined sections using gain information extracted from the bit streams and adjusts amplitudes of the output signals so that each section is the same as gain information of a corresponding section extracted from the bit streams. When the average energy of each section is used as gain information, the amplitudes of the signals are adjusted so that the average energy of each section coincides with the average energy of a corresponding section included in the gain information. The amplitudes of the high frequency signals copied in this way are adjusted using the gain information to adjust time envelopes so that the residual signals of high frequency signals are generated.

Referring back to FIG. 4, the LPC synthesizing unit 440 restores the high frequency signals from the LPC coefficients of the high frequency signals extracted from the bit streams by using LPC synthesis, which is a reverse operation of LPC analysis, and the residual signals of the high frequency signals generated by the high frequency residual signal generating unit 430. Meanwhile, the LPC synthesizing unit 440 may transform the LPC coefficients into line spectral frequencies (LSF) and may interpolate the converted LSF to perform LPC synthesis.

The low frequency signals restored by the low frequency signal decoding unit 420 and the high frequency signals restored by the LPC synthesizing unit 440 are combined with one another so that audio signals can be restored.

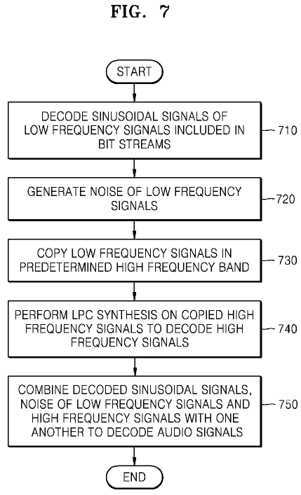

FIG. 7 is a flowchart illustrating a method of decoding audio signals according to an exemplary embodiment of the present invention.

Referring to FIG. 7, in operation 710, a decoding operation is performed on sinusoidal signals which are extracted from low frequency signals of less than a predetermined critical frequency, which are included in bit streams and are encoded.

In operation 720, noise of the low frequency signals is generated using a predetermined random signal generation function and is combined with the decoded sinusoidal signals so that the low frequency signals can be decoded. As described above, noise of the low frequency signals may be generated by generating random signals using the random signal generation function, adjusting envelopes of the random signals using gain information about residual signals of difference signals to generate prediction noise signals of the low frequency signals and then by performing LPC synthesis using the LPC coefficients extracted from the bit streams and the prediction noise signals.

In operation 730, the residual signals of the high frequency signals of the audio signals are generated using the decoded low frequency signals. As described above, the residual signals of the high frequency signals may be generated by copying the residual signals of the low frequency signals generated by performing spectral whitening on the decoded low frequency signals in a predetermined high frequency band, adding tone and noise to the signals copied by using information about the ratio of tone to noise included in the bit streams, and adjusting envelopes of the signals copied using gain information of the high frequency signals included in the bit streams.

In operation 740, LPC synthesis using the LPC coefficients of the high frequency signals included in the bit streams and the residual signals of the high frequency signals is performed so that the high frequency signals can be decoded.

In operation 750, the decoded low frequency signals and the decoded high frequency signals are combined with one another so that the audio signals can be decoded.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices.

In another exemplary embodiment, the invention can be embodied as carrier waves (such as data transmission through the Internet).

The computer readable recording medium can also be distributed over network coupled computer systems so that the computer readable code is stored and executed in a distributed fashion.

According to the present invention, effective coding of high frequency component signals included in input audio signals is possible while reducing the amount of bits generated.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of encoding audio signals, the method comprising:
performing sinusoidal analysis on low frequency signals of less than a critical frequency included in the audio signals, in order to extract sinusoidal signals;
performing linear prediction coding (LPC) analysis on remaining difference signals excluding the sinusoidal signals extracted from the audio signals, to generate LPC coefficients and residual signals of the difference signals;
extracting gain information about the residual signals of the difference signals; and
multiplexing the sinusoidal signals, the LPC coefficients of the difference signals, and the gain information about the residual signals of the difference signals.

2. The method of claim 1, wherein the difference signals include noise components of the low frequency signals, tone components of high frequency signals, and noise components of the high frequency signals.

3. The method of claim 1, further comprising:
calculating a ratio of tone to noise components of the audio signals; and
adding the ratio of tone to noise components to bit streams generated as a result of the multiplexing.

4. The method of claim 3, wherein the calculating the ratio of tone to noise components of the audio signals comprises:
transforming the audio signals into a frequency domain; and
calculating the ratio of tone to noise components in a frequency band unit of the audio signals transformed into the frequency domain.

5. The method of claim 1, wherein the gain information comprises parameter information in which time envelopes of the residual signals are modeled.

6. The method of claim 5, wherein the extracting the gain information about the residual signals of the difference signals comprises:
dividing the time envelopes of the residual signals into sections; and
generating parameters indicating a change in amplitudes of the time envelopes of the residual signals using an energy of each divided section.

7. An apparatus for encoding audio signals, the apparatus comprising:
a sinusoidal extracting unit which performs sinusoidal analysis on low frequency signals of less than a critical frequency included in the audio signals, in order to extract sinusoidal signals;
a linear prediction coding (LPC) analyzing unit which performs LPC analysis on remaining difference signals excluding the sinusoidal signals extracted from the audio signals, to generate LPC coefficients and residual signals of the difference signals;
an envelope encoding unit which extracts gain information about the residual signals of the difference signals; and
a multiplexing unit which multiplexes the sinusoidal signals, the LPC coefficients of the difference signals, and the gain information about the residual signals of the difference signals.

8. The apparatus of claim 7, wherein the difference signals include noise components of the low frequency signals, tone components of high frequency signals, and noise components of the high frequency signals.

9. The apparatus of claim 7, further comprising a tone/noise calculating unit which calculates a ratio of tone to noise components of the audio signals.

10. The apparatus of claim 9, wherein the tone/noise calculating unit transforms the audio signals into a frequency domain and calculates the ratio of tone to noise components in a frequency band unit of the audio signals transformed into the frequency domain.

11. The apparatus of claim 7, wherein the gain information comprises parameter information in which time envelopes of the residual signals are modeled.

12. The apparatus of claim 11, wherein the envelope encoding unit divides the time envelopes of the residual signals into sections and generates parameters indicating a change in amplitudes of the time envelopes of the residual signals using an energy of each divided section.

13. A method of decoding audio signals, the method comprising:
performing a decoding operation on encoded sinusoidal signals which are extracted from low frequency signals less than a critical frequency signal included in bit streams;
generating noise of the low frequency signals using a random signal generation function and combining the noise with the sinusoidal signals so as to decode the low frequency signals;
generating residual signals of high frequency signals of the audio signals by using the decoded low frequency signals;
performing linear prediction coding (LPC) synthesis using LPC coefficients of the high frequency signals included in the bit streams and residual signals of the high frequency signals so as to decode the high frequency signals; and
combining the decoded low frequency signals with the high frequency signals so as to decode the audio signals.

14. The method of claim 13, wherein the generating the noise of the low frequency signals comprises:
generating random signals by using the random signal generation function;
extracting gain information about residual signals of difference signals, the difference signals representing a difference between the audio signals and the sinusoidal signals, from the bit streams and adjusting envelopes of the random signals by using the extracted gain information to generate prediction noise signals of the low frequency signals; and
performing LPC synthesis using the LPC coefficients extracted from the bit streams and the prediction noise signals, in order to generate noise of the low frequency signals.

15. The method of claim 13, wherein the generating of the residual signals of the high frequency signals of the audio signals comprises:
performing spectral whitening on the decoded low frequency signals so as to generate residual signals of the decoded low frequency signals;
copying the residual signals of the low frequency signals in a high frequency band;
adding tone and noise to the signals copied in the high frequency band by using information about a ratio of tone to noise included in the bit streams; and
adjusting envelopes of the signals copied in the high frequency band by using gain information about the high frequency signals included in the bit streams.

16. An apparatus for decoding audio signals, the apparatus comprising:
a low frequency signal decoding unit which performs a decoding operation on encoded sinusoidal signals which are extracted from low frequency signals less than a critical frequency signal included in bit streams, and combining a noise of the low frequency signals generated using a random signal generation function with the sinusoidal signals in order to decode the low frequency signals;
a high frequency residual signal generating unit which generates residual signals of high frequency signals of the audio signals by using the decoded low frequency signals;
a linear prediction coding (LPC) synthesizing unit which performs LPC synthesis using LPC coefficients of the high frequency signals included in the bit streams and residual signals of the high frequency signals so as to decode the high frequency signals; and
a combining unit which combines the decoded low frequency signals with the high frequency signals to decode the audio signals.

17. The apparatus of claim 16, wherein the low frequency signal decoding unit comprises:
a sinusoidal signal decoding unit which decodes the sinusoidal signals;
a noise generating unit which generates random signals by using the random signal generation function;
an envelope adjusting unit which extracts gain information about residual signals of difference signals, the difference signals representing a difference between the audio signals and the sinusoidal signals, from the bit streams and adjusting envelopes of the random signals by using the extracted gain information so as to generate prediction noise signals of the low frequency signals; and
a low frequency noise generating unit which performs LPC synthesis using the LPC coefficients extracted from the bit streams and the prediction noise signals, in order to generate noise of the low frequency signals.

18. The apparatus of claim 16, wherein the high frequency residual signal generating unit comprises:
a spectral whitening performing unit which performs spectral whitening on the decoded low frequency signals so as to generate residual signals of the decoded low frequency signals;
a high frequency band copying unit which copies the residual signals of the low frequency signals in a high frequency band;
a tone/noise adjusting unit which adds tone and noise to the signals copied in the high frequency band by using information about a ratio of tone to noise included in the bit streams; and
an envelope adjusting unit which adjusts envelopes of the signals copied in the high frequency band by using gain information about the high frequency signals included in the bit streams.

19. A computer readable recording medium having recorded thereon a program for executing the method of claim 1.

20. A computer readable recording medium having recorded thereon a program for executing the method of claim 13.
